(19) United States
(12) Patent Application Publication
(10) Pub. No.: US 2004/0045023 A1
(43) Pub. Date: Mar. 4, 2004

(54) Digital/analog broadcast receiver

(76) Inventors: Keisuke Tsukamoto, Osaka (JP); Toshihiro Takagi, Osaka (JP); Yasuhiro Inui, Osaka (JP); Tatsuo Miyagawa, Osaka (JP)

Correspondence Address: JONATHAN P. OSHA, ROSENTHAL & OSHA LLP, STE 2800, 1221 MCKINNEY ST, HOUSTON, TX, 77010-2026, US

(21) Appl. No.: 10/347,975

(22) Filed: Jan. 21, 2003

(30) Foreign Application Priority Data
Jan. 21, 2002 (JP) P2002-011263

(51) Int. Cl. G06F 3/00; H04N 5/445; G06F 13/00; H04N 7/173; H04N 7/16

(52) U.S. Cl. 725/39; 725/58; 725/131; 725/139; 725/151

(57) ABSTRACT

A name of a television program whose electronic program information is absent is not displayed on an EPG screen when it is displayed. At this time, a user operates a broadcast receiver to prepare a temporary program for selecting the television program whose electronic program information is absent, on the EPG screen. The temporary program prepared is displayed in a program column where its program name is not displayed on the EPG screen, and the television program whose electronic program information is absent can be selected, like a television program whose name is displayed. The user selects the temporary program on the EPG screen, and performs a program reservation operation, whereby the viewer reserves a television program of a channel, which is associated with the temporary program being displayed and to be broadcast at a broadcast time.

The present disclosure relates to the subject matter contained in Japanese Patent Application No. 2002-011263 filed Jan. 21, 2002, which is incorporated herein by reference in its entirety.

### BACKGROUND OF THE INVENTION

1. Field of the Invention

The present invention relates to a digital/analog broadcast receiver capable of reserving the viewing and the recording of television programs by the use of an EPG (Electric Program Guide) screen displayed on a television monitor.

2. Description of the Related Art

Information about current and future television programs such as program names, broadcasting times and broadcasting channels are distributed together with video and audio signals of the television programs transmitted from a broadcasting station. Such information on the television programs is called an Event Information Table (EIT).

Television broadcasting systems that distribute such electronic program information are: in Japan, BS (Broadcasting Satellite) digital broadcasting, NTSC (National Television Systems Committee) analog broadcasting, and others; and in North America, ATSC (Advanced Television Systems Committee) digital broadcasting, NTSC analog broadcasting, and others. In the digital broadcasting system such as the ATSC and BS, the electronic program information, together with the video and audio signals of the television programs, are time-division multiplexed into a TS (Transport Stream) in a television broadcast signal, and the resultant is distributed. In the analog broadcasting system such as the NTSC, the electronic program information is contained in a VBI (Vertical Blanking Interval) signal in the television broadcast signal, and the resultant is distributed. The electronic program information in those television broadcasting systems only includes information about programs that are broadcasted by each television broadcasting system.

A broadcast receiver for receiving the television broadcast signal is known which displays an EPG screen containing a list of television programs on the basis of electronic program information contained in the television broadcast signal. A user selects a desired television program displayed on the EPG screen and makes the program reservation such as the viewing reservation or the recording reservation. Another broadcast receiver is also known. The broadcast receiver has an EPG screen displaying function and a program reservation function utilizing an EPG screen, and is capable of receiving television broadcast signals of different broadcasting systems, such as the BS broadcasting system, the NTSC broadcasting system in Japan, and ATSC broadcasting system and NTSC broadcasting system in the North America.

The broadcast receiver capable of receiving television broadcast signals of different broadcasting systems receives a television broadcast signal of one of the broadcasting systems, and displays the EPG screen on the basis of electronic program information contained in the broadcast signal. In the case of the broadcast receiver capable of receiving both the ATSC broadcasting system and the NTSC broadcasting system, when the broadcast receiver receives an ATSC broadcast signal, the broadcast receiver displays the EPG screen based on the electronic program information contained in the broadcast signal. Accordingly, on the EPG screen in the ATSC broadcast, only the electronic program information of the ATSC broadcast is obtained, and the electronic program information of the NTSC broadcast cannot be obtained. Thus, only the television programs broadcasted by the ATSC broadcast are displayed in the form of a program list.

A display example on the EPG screen in the ATSC broadcast is shown in FIG. 8. On an EPG screen 70, a channel column 71 contains channel numbers, and a program column 72 located next to the channel column 71 contains program names to be broadcasted by the channels. Broadcast time of the program is displayed above the program column 72. Thus, the EPG screen 70 displays the television programs in connection with its broadcast channel and broadcast time.

On the EPG screen 70, “2-1”, “2-2”, “2-3” and “8-1” are channel numbers in the ATSC broadcast, and “4” and “6” are channel numbers in the NTSC broadcast. In the program column 72, program names are displayed corresponding to “2-1”, “2-2”, “2-3” and “8-1” as the channel numbers in the ATSC broadcast. Electronic program information of the NTSC broadcast is not displayed on the EPG screen 70 of the ATSC broadcast. Accordingly, no program names are displayed at locations corresponding to the channel numbers “4” and “6” of the NTSC broadcast in the program column 72.

A digital BS broadcast receiver is known in which terrestrial broadcast EPG data is transmitted as one of service data of the digital BS broadcast, and the digital BS broadcast receiver receives the terrestrial broadcast EPG data. The digital BS broadcast EPG and the terrestrial broadcast EPG are both displayed on the monitor television (see JP-A-10-79935, for example). A teletext broadcasting receiver capable of preparing a program table of television programs is known. The receiver acquires not only the broadcast programs of plural channels in the analog broadcasting, but also program information of broadcast programs of plural channels in the digital broadcasting, and displays those programs on the same program table (see JP-A-2000-69436, for example). A broadcast contents receiver is also known. The receiver displays the program contents on the television receiver in a format resembling a television program column of newspaper, based on information including television program contents, start time, broadcasting channel, which are input through input means from exterior (see Japanese Patent No. 2838892, for example).

In the conventional broadcast receiver thus constructed, information such as a name of the television program whose electronic program information is absent when the EPG screen is displayed are not displayed on the EPG screen. Accordingly, the user cannot select, on the EPG screen, the television program whose electronic program information is absent when the EPG screen is displayed, and hence cannot make the viewing or recording reservation by the use of the EPG screen.

In those publications, JP-A-10-79935 and JP-A-2000-69436, and Japanese Patent No. 2838892, after obtaining television program information, such as program name, broadcast time and broadcast channel, the broadcast receiver displays the program name and the like on the television monitor. Therefore, the broadcast receiver cannot reserve the television program which cannot be displayed on the EPG screen since its television program information is absent, by the use of the EPG screen

### SUMMARY OF THE INVENTION

Accordingly, an object of the invention is to provide a digital/analog broadcast receiver which can reserve, by the use of an EPG screen, the viewing and the recording of a television program whose name is not displayed on the EPG screen since their electronic program information is absent.

According to one aspect of the present invention, there is provided a digital/analog broadcast receiver comprising: a receiving section for receiving a television broadcast signal distributed from a broadcasting station; a decoder for generating a signal for displaying on a television monitor connected to the digital/analog broadcast receiver a video image based on a video signal contained in the television broadcast signal that is received by the receiving section; EPG screen displaying function means for displaying on the television monitor an EPG (Electric Program Guide) screen containing a list of television programs on a basis of electronic program information contained in the television broadcast signal received by the receiving section; an operation section operated by a user to select a television program displayed on the EPG screen and to perform various operations on the digital/analog broadcast receiver; program reserving means for reserving at least one of the viewing and recording of a television program displayed on the EPG screen by selecting the program by the operation section; and temporary program preparing means for preparing a temporary program that enables the user to select a television program not displayed on the EPG screen since its electronic program information is absent, wherein a plurality of time intervals are preset as time intervals in the temporary program preparing means, the time interval is selected by the operation section, and responsively a temporary program is prepared having the selected time interval, the EPG screen displaying function means displays the temporary program at a location on the EPG screen where a television program based on the electronic program information is not displayed, and the program reserving means enables the user to make at least one of a viewing reservation and a recording reservation of a television program of a channel and broadcast time, which correspond to the location where the temporary program is displayed, by selecting one or plurality of temporary programs displayed on the EPG screen by the operation section, and enables the user to assign a title to the reserved temporary program and displays the title on the EPG screen.

In the digital/analog broadcast receiver thus constructed, when a television program which is not displayed on the EPG screen since its electronic program information is absent, is selected, a temporary program can be prepared which enables the user to select the program on the EPG screen. For preparing the temporary program, the user selects a time interval and prepares the temporary program. The prepared temporary program is displayed at the selected time interval at a location on the EPG screen where the electronic program information is not displayed since its electronic program information is absent. The user makes a viewing reservation or a recording reservation of a television program of a channel and broadcast time, which correspond to the location where the temporary program is displayed, by selecting one or plurality of temporary programs displayed on the EPG screen by the operation section. Accordingly, the electronic program information which is not displayed since its electronic program information is absent, is also reserved for its viewing or recording. A title may be assigned to the temporary program reserved.

According to another aspect of the invention, there is provided a digital/analog broadcast receiver comprising: a receiving section for receiving a television broadcast signal distributed from a broadcasting station; a decoder for generating a signal for displaying on a television monitor connected to the digital/analog broadcast receiver a video image based on a video signal contained in the television broadcast signal that is received by the receiving section; EPG screen displaying function means for displaying on the television monitor an EPG (Electric Program Guide) screen containing a list of television programs on a basis of electronic program information contained in the television broadcast signal received by the receiving section; an operation section operated by a user to select a television program displayed on the EPG screen and to perform various operations on the digital/analog broadcast receiver; program reserving means for reserving at least one of the viewing and recording of a television program displayed on the EPG screen by selecting the program by the operation section; and temporary program preparing means for preparing a temporary program that enables the user to select a television program not displayed on the EPG screen since its electronic program information is absent, wherein the EPG screen displaying function means displays the temporary program at a location on the EPG screen where a television program based on the electronic program information is not displayed, and the program reserving means enables the user to make at least one of a viewing reservation and a recording reservation of a television program of a channel and broadcast time, which correspond to the location where the temporary program is displayed, by selecting the temporary programs displayed on the EPG screen by the operation section.

In the digital/analog broadcast receiver thus constructed, when a television program which is not displayed on the EPG screen since its electronic program information is absent, is selected, a temporary program can be prepared which enables the user to select the program on the EPG screen. The temporary program is prepared through the user's program preparing operation. The prepared temporary program is displayed at a location on the EPG screen where the electronic program information is not displayed since its electronic program information is absent. The user makes a viewing reservation or a recording reservation of a television program of a channel and broadcast time, which correspond to a location where the temporary program is displayed, by selecting the temporary programs displayed on the EPG screen by the operation section. Accordingly, the electronic program information which is not displayed since its electronic program information is absent, is also reserved for its viewing or recording.

In the digital/analog broadcast receiver, in the temporary program preparing means, a plurality of time intervals are preset as time intervals forming the temporary program, the time interval is selected by the operation section, and responsively a temporary program is prepared having the selected time interval. With this feature, the user can select a time interval of the temporary program as desired.

### BRIEF DESCRIPTION OF THE DRAWINGS

FIG. 1 is a block diagram showing an electrical arrangement of a digital/analog broadcast receiver that is an embodiment of the invention;

FIGS. 2(a), 2(b) and 2(c) are exemplar displays of a temporary program on an EPG screen of an ATSC broadcasting in the digital/analog broadcast receiver;

FIG. 3 is a diagram showing a display useful in explaining how to reserve a program by the use of the temporary program in the digital/analog broadcast receiver;

FIGS. 4(a), 4(b) and 4(c) are diagrams showing displays useful in explaining another program reserving method based on the temporary program in the broadcast receiver;

FIG. 5 is a diagram showing a display useful in explaining how to register a title of the temporary program reserved, in the broadcast receiver;

FIG. 6 is a flow chart showing a flow of a preparing process of preparing a temporary program in the broadcast receiver;

FIG. 7 is a flowchart showing a flow of a program reserving process by the use of the temporary program in the digital/analog broadcast receiver; and

FIG. 8 shows a conventional EPG screen.

### DETAILED DESCRIPTION OF THE PREFFERED EMBODIMENTS

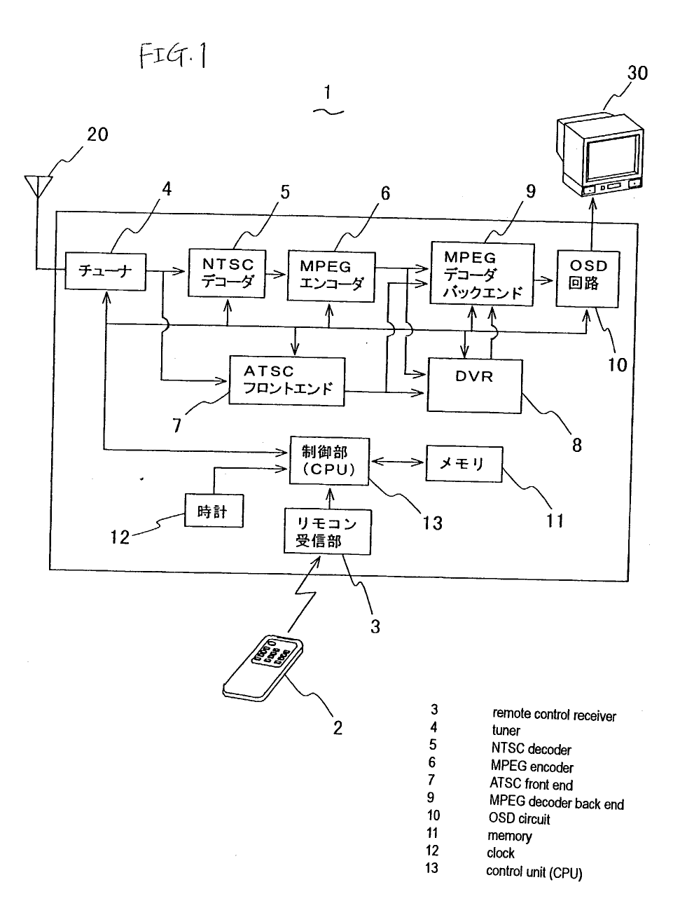

Embodiments of the present invention will be described with reference to the accompanying drawings. A block diagram showing an electrical arrangement of a digital/analog broadcast receiver that is an embodiment of the invention, is shown in FIG. 1. A digital/analog broadcast receiver (STB) 1 is connected to an antenna 20 for receiving a television broadcast signal that is transmitted in the form of a radio wave of a predetermined frequency from a broadcasting station, and to a television monitor 30 for displaying a video image of a television broadcast.

The broadcast receiver 1 receives an ATSC broadcast signal and an NTSC broadcast signal that are transmitted from broadcasting stations through the antenna 20, and displays video images of television programs distributed by the broadcast signals on the television monitor 30. The broadcast receiver 1 has a function to record video images of television programs distributed by those broadcast signals.

The broadcast receiver 1 includes a remote controller (operation section) 2, a remote control receiver 3, a tuner (receiving section) 4, an NTSC decoder 5, an MPEG encoder 6, an ATSC front end 7, a DVR (digital video recorder) 8, an MPEG decoder back end (decoder) 9, an OSD circuit 10, a memory 11, a clock 12, and a control unit (EPG screen display function means, temporary program preparing means, program reserving means) 13.

The remote controller 2 is used by the user for various operations; channel selection of a television program to be viewed, viewing and recording reservations of television programs, displaying of the EPG screen, and preparing of temporary programs. The “temporary program” enables the user to select a television program that is not displayed on the EPG screen since its electronic program information is absent, and is prepared by the user through his or her operation of the remote controller 2. The remote controller 2 includes various operation buttons (not shown) for those kinds of operations. When any of those buttons is operated, the remote controller wirelessly emits an infrared rays signal representative of its operation.

The remote control receiver 3 receives a signal from the remote controller 2, and outputs a signal representative of an operation on the remote controller 2 to the control unit 13. The tuner 4 tunes its receiving signal frequency to a frequency corresponding to a channel selected by the remote controller 2, whereby it receives a television broadcast signal of the selected channel through the antenna 20.

When a channel of the NTSC broadcast is selected by the remote controller 2, the NTSC decoder 5 decodes the NTSC broadcast signal received by the tuner 4 into video and audio signals of the television program, and outputs the video and audio signals to the MPEG encoder 6. The MPEG encoder 6 digitally compresses and encodes the video and audio signals from the NTSC decoder 5 according to the MPEG standards, and sends the resultant to the MPEG decoder back end 9.

When a channel of the ATSC broadcast is selected by the remote controller 2, the ATSC front end 7 decodes the ATSC broadcast signal, which is received by the tuner 4 and modulated by the 8VSB method, into a TS signal in which the video and audio signals of plural television programs that are MPEG processed and the electronic program information signal are time-division multiplexed. The ATSC front end 7 separates and extracts the video and audio signals of the television program of the channel selected by the remote controller 2 from the TS signal, and outputs the separated one to the MPEG decoder back end 9, and extracts electronic program information therefrom and outputs to the control unit 13.

The DVR 8 records the video and audio signals from the MPEG encoder 6 and the ATSC front end 7 under control by the control unit 13, reproduces the recorded video and audio signals and outputs the resultant to the MPEG decoder back end 9. The DVR 8 carries out the recording and reproducing processes of the video and audio signals in a state that those signals are digitally compressed and encoded according to the MPEG standards.

The MPEG decoder back end 9 receives the video and audio signals output from the MPEG encoder 6, ATSC front end 7 and DVR 8, which signals are digitally compressed and encoded according to the MPEG standards. The MPEG decoder back end 9 decodes the video and audio signals so that those signals become original state in which those are not digitally compressed and encoded, thereby generating signals for displaying a video image on the television monitor 30 and outputting a sound. The video signal output from the MPEG decoder back end 9 is output to the television monitor 30 via the OSD circuit 10.

The OSD circuit 10 superimposes a channel number and given on-screen display data of EPG screen and the like to the video signal output from the MPEG decoder back end 9. As a result, an image based on the on-screen display data is displayed on the television monitor 30, while being superimposed on a video image of the television program.

The memory 11 stores data of a temporary program that is prepared by the control unit 13 according to an operation by the remote controller 2. The memory 11 stores frequency data of television broadcast signals of channels and various kinds of on-screen display data. The clock 12 counts the date and time and outputs its signal to the control unit 13.

When a channel of the NTSC broadcasting is selected by the remote controller 2, the control unit 13 causes the tuner 4 to receive an NTSC broadcast signal of the selected channel, and causes the NTSC decoder 5 to decode the video and audio signals. When a channel of the ATSC broadcasting is selected by the remote controller 2, the control unit causes the tuner 4 to receive an ATSC broadcast signal of the selected channel, and causes the ATSC front end 7 to separate and extract the video and audio signals of the selected channel.

When the remote controller 2 is operated for displaying the EPG screen, the control unit 13 causes the tuner 4 to receive an ATSC broadcast signal, and prepares a display image of the EPG screen based on electronic program information output from the ATSC front end 7, and outputs the resultant to the OSD circuit 10. As a result, the EPG screen of the ATSC broadcast is displayed on the television monitor 30.

When a temporary program is prepared by the use of the remote controller 2, the control unit 13 prepares a temporary program and stores data of the prepared temporary program to the memory 11. When the user operates the remote controller 2 to select a television program on the EPG screen and to reserve its viewing or recording by the use of the remote controller 2, the control unit 13 reserves the viewing or recording of the program, and stores the reservation data into the memory 11.

The temporary program is prepared in a manner that the user operates the remote controller 2 to display the EPG screen, and to prepare the temporary program in a state that the EPG screen is being displayed. Time intervals of the temporary program that can be prepared are three intervals, 30 min., 60 min. and 120 min. A desired time interval is selected by the use of the remote controller 2. The prepared temporary programs are displayed at all the locations on the EPG screen where the television programs are not displayed since the electronic program information are absent.

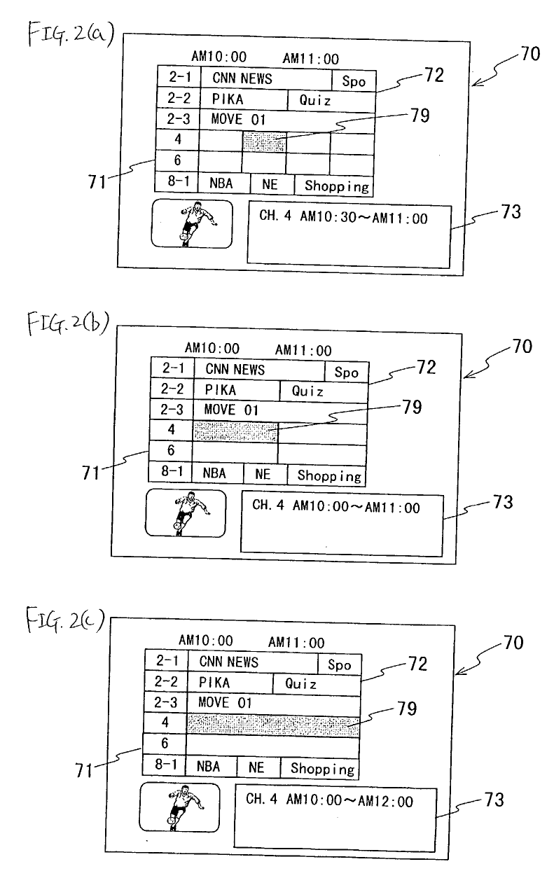

Exemplar displays of a temporary program on an EPG screen of an ATSC broadcasting is shown in FIGS. 2(a) to 2(c). FIG. 2(a) shows the display when the time interval of the temporary program is set at 30 min; FIG. 2(b) is the display when it is set at 60 min., and FIG. 2(c) is the display when it is set at 120 min. As shown in FIG. 2(a), a broadcast channel is displayed in the channel column 71 on the EPG screen 70, and a television program name to be broadcast by the channel is displayed in the program column 72 located on the side of the channel column 71. A broadcast time of the television program is displayed above the program column 72. Thus, the EPG screen 70 displays the television programs in connection with its broadcast channel and broadcast time.

On the EPG screen 70, “2-1”, “2-2”, “2-3” and “8-1” are channel numbers in the ATSC broadcast, and “4” and “6” are channel numbers in the NTSC broadcast. In the program column 72, program names are presented corresponding to “2-1”, “2-2”, “2-3” and “8-1” as the channel numbers in the ATSC broadcast. Electronic program information of the NTSC broadcast is not displayed on the EPG screen of the ATSC broadcast. Accordingly, a plurality of temporary programs 79 are displayed at a time interval of 30 min. at locations corresponding to the channel numbers “4” and “6” of the NTSC broadcast in the program column 72.

The temporary programs 79 displayed on the EPG screen 70 may be selected by operating the remote controller 2, like the program of the ATSC broadcasting of which the program name is displayed. A broadcast channel and its broadcasting time of the temporary programs 79 selected by a cursor are displayed in a message column 73.

The EPG screens 70 shown in FIGS. 2(b) and 2(c) are the same as that of FIG. 2(a) except that the time intervals of the temporary programs 79 are 60 min. and 120 min. The prepared temporary program data is stored into the memory 11. In the subsequent EPG screen, the temporary program is likewise displayed at its location where the television program is not displayed since the electronic program information is absent.

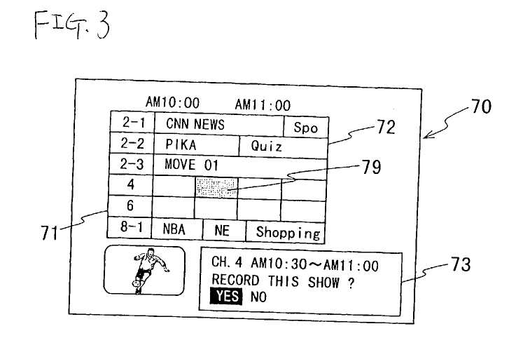

To reserve the viewing or recording of a program on the EPG screen by the use of the thus prepared temporary program, as shown in FIG. 3, the user causes the receiver to display the EPG screen 70, selects a temporary program 79 corresponding to a channel to be reserved and its broadcast time, by operating the remote controller 2, and turns on a REC button (the viewing reservation button in order to reserve the viewing of the program) of the remote controller 2. In the instance of FIG. 3, a temporary program 79 of channel “4” and 10:30 to 11:00 is selected, and a confirmation message of the program reservation is displayed in the message column 73. To determine the program reservation, the user operates the remote controller 2 and selects characters “YES” in the message column 73, and turns on an ENTER button of the remote controller 2.

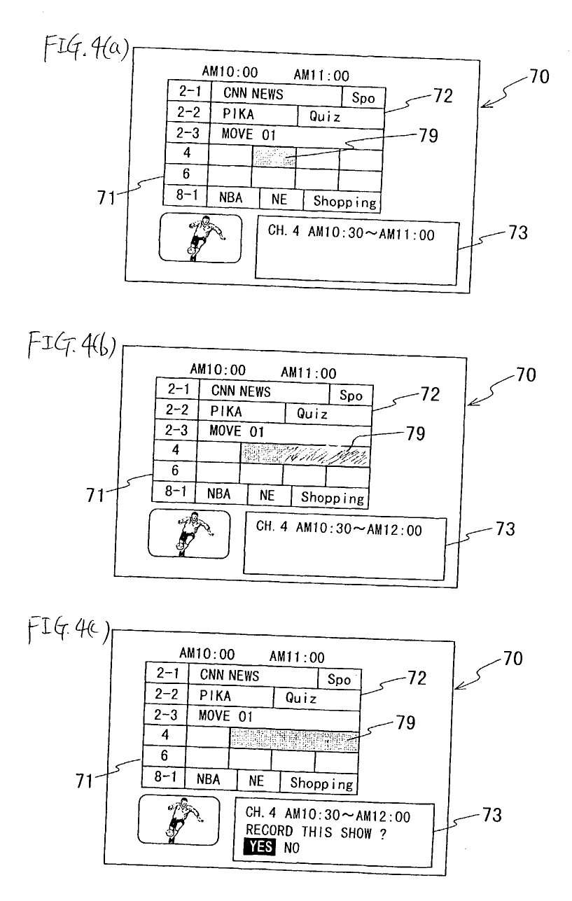

For example, in a case where temporary programs are prepared at the time interval of 30 min. and a program of 1 hour and 30 minutes is reserved, to reserve plural adjacent temporary programs as a single program, the program reservation is carried out in a method as shown in FIGS. 4(a) to 4(c). To start, the user operates the remote controller 2 to select a temporary program 79 corresponding to a channel to be reserved and its broadcast time, and turns on the ENTER button of the remote controller 2 (FIG. 4(a)). Then, the user presses a RIGHT button of the remote controller 2 to select and widen a range of the temporary program 79 to be reserved (FIG. 4(b)).

And the user turns on the REC button (the viewing reservation button in order to reserve the viewing of the program) of the remote controller 2 to determine the range of the temporary program 79 to be reserved. In the instance of FIG. 4(c), a temporary program 79 of channel “4” and 10:30 to 12:00 is selected, and a confirmation message of the program reservation is displayed in the message column 73. To determine the program reservation, the user operates the remote controller 2 and selects characters “YES” in the message column 73, and turns on an ENTER button of the remote controller 2.

As shown in FIG. 5, a title (program name) may be assigned to the temporary program 79 to be reserved by operating the remote controller 2. In an instance of FIG. 5, a title “SUCCER” is assigned to the temporary program 79 to be reserved. In the subsequent EPG screen 70, the temporary program 79 having the title is treated as one program, and its title is displayed, and the program is displayed, like other programs.

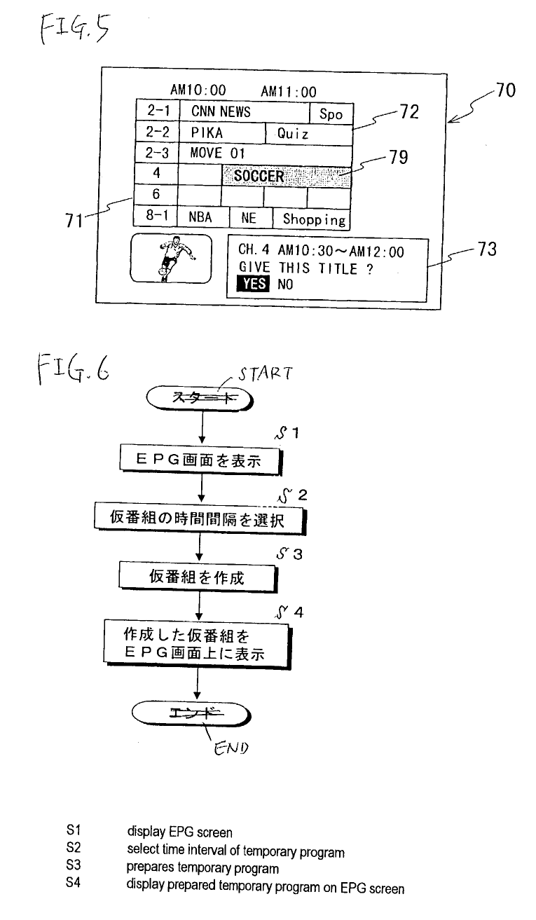

A flow of a preparing process of preparing a temporary program in the digital/analog broadcast receiver of this embodiment will be described with reference to a flow chart of FIG. 6. To start, the user operates the remote controller 2 to display the EPG screen (S1). The user operates the remote controller 2 to select a time interval of a temporary program by operating the remote controller 2 (S2). In turn, the broadcast receiver 1 prepares a temporary program of the selected time interval (S3), and displays the prepared temporary program on the EPG screen.

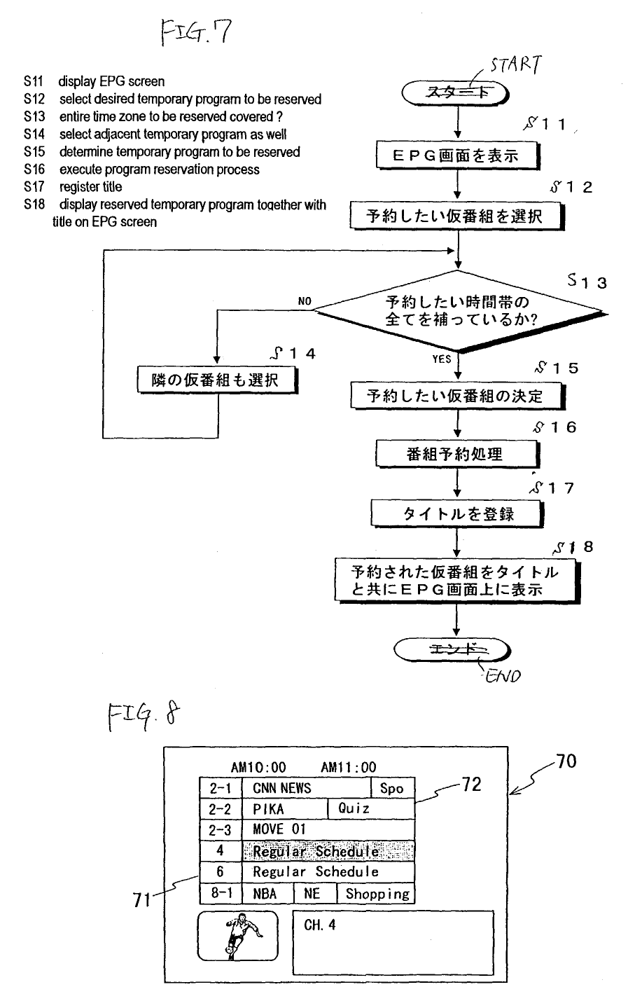

A flow of a program reserving process by the use of the temporary program in the digital/analog broadcast receiver will be described with reference to a flow chart of FIG. 7. To start, the user operates the remote controller 2 to display the EPG screen (S11). The user selects a temporary program to be reserved on the EPG screen (S12). If the temporary program to be reserved does not cover the entire time zone to be program reserved (NO in a step S13), the user operates the remote controller 2 and selects a temporary program adjacent to it as well (S14).

If the temporary program to be reserved covers the entire time zone to be program reserved (YES in a step S13), the user turns on a REC button (the viewing reservation button in order to reserve the viewing of the program) of the remote controller 2 to determine a temporary program to be desired (S15). The broadcast receiver 1 carries out a program reservation process of the channel and the broadcast time at the location on the EPG screen at which the selected temporary program is displayed, according to the operation of determining the temporary program by the remote controller 2 (S16) Thereafter, the user registers a title of the reserved temporary program by operating the remote controller 2 (S17). The broadcast receiver 1 displays the reserved temporary program, together with the registered title on the EPG screen (S18).

In the digital/analog broadcast receiver 1 thus constructed, by preparing a temporary program by operating the remote controller 2, a temporary program is displayed at a location on the EPG screen where the television program is not displayed since the electronic program information is absent. And, by selecting the temporary program displayed on the EPG screen, the user makes a viewing reservation or a recording reservation of a television program of a channel and broadcast time, which correspond to a location where the temporary program is displayed. Further, the user can assign a title to the reserved temporary program and displays it on the EPG screen.

The present invention is not limited to the embodiment mentioned above, but may variously be modified, altered and changed within the true spirits and scope of the invention. While in the embodiment, the broadcast receiver is discussed which is for receiving the ATSC broadcasting, it will readily be understood that the invention may be applied to a broadcast receiver for receiving a BS broadcast signal OFDM modulated or to a broadcast receiver for receiving a broadcast signal of another broadcasting system.

In the embodiment, the temporary program may be prepared in a state that the EPG screen is not displayed. The broadcast receiver may be integrated with the television monitor.

As seen from the foregoing description, according to a first aspect of the invention, by preparing the temporary program, the electronic program information which is not displayed on the EPG screen since its electronic program information is absent, can also reserved for its viewing or recording by the utilization of the EPG screen, like the television program displayed on the EPG screen. Accordingly, the television programs of all the channels which can be received by the broadcast receiver can be reserved by the use of the EPG screen in a simple operation. If the time interval of the temporary program is made to correspond to a broadcast time of a television program to be reserved, the temporary program on the EPG screen is satisfactorily reserved by merely selecting the temporary program on the EPG screen one time. A title may be assigned to the reserved temporary program. Accordingly, the temporary program is displayed in a style resembling that of another program displayed on the EPG screen, as is easy to view. This feature is convenient.

According to a second aspect of the invention, by preparing the temporary program, the electronic program information which is not displayed on the EPG screen since its electronic program information is absent, can also reserved for its viewing or recording by the utilization of the EPG screen, like the television program displayed on the EPG screen. Accordingly, the television programs of all the channels which can be received by the broadcast receiver can be reserved by the utilization of the EPG screen in a simple operation.

According to a third aspect of the invention, the time interval of the temporary program may be selected as desired. If the time interval of the temporary program is made to correspond to a broadcast time of a television program to be reserved, the temporary program on the EPG screen is satisfactorily reserved by merely selecting the temporary program on the EPG screen one time.

What is claimed is:

1. A digital/analog broadcast receiver comprising:
a receiving section for receiving a television broadcast signal distributed from a broadcasting station;
a decoder for generating a signal for displaying on a television monitor connected to the digital/analog broadcast receiver a video image based on a video signal contained in the television broadcast signal that is received by the receiving section;
EPG screen displaying function means for displaying on the television monitor an EPG (Electric Program Guide) screen containing a list of television programs on a basis of electronic program information contained in the television broadcast signal received by the receiving section;
an operation section operated by a user to select a television program displayed on the EPG screen and to perform various operations on the digital/analog broadcast receiver;
program reserving means for reserving at least one of the viewing and recording of a television program displayed on the EPG screen by selecting the program by the operation section; and
temporary program preparing means for preparing a temporary program that enables the user to select a television program not displayed on the EPG screen since its electronic program information is absent,
wherein a plurality of time intervals are preset as time intervals in the temporary program preparing means,
the time interval is selected by the operation section, and responsively a temporary program is prepared having the selected time interval,
the EPG screen displaying function means displays the temporary program at a location on the EPG screen where a television program based on the electronic program information is not displayed, and
the program reserving means enables the user to make at least one of a viewing reservation and a recording reservation of a television program of a channel and broadcast time, which correspond to the location where the temporary program is displayed, by selecting one or plurality of temporary programs displayed on the EPG screen by the operation section, and enables the user to assign a title to the reserved temporary program and displays the title on the EPG screen.

2. A digital/analog broadcast receiver comprising:
a receiving section for receiving a television broadcast signal distributed from a broadcasting station;
a decoder for generating a signal for displaying on a television monitor connected to the digital/analog broadcast receiver a video image based on a video signal contained in the television broadcast signal that is received by the receiving section;
EPG screen displaying function means for displaying on the television monitor an EPG (Electric Program Guide) screen containing a list of television programs on a basis of electronic program information contained in the television broadcast signal received by the receiving section;
an operation section operated by a user to select a television program displayed on the EPG screen and to perform various operations on the digital/analog broadcast receiver;
program reserving means for reserving at least one of the viewing and recording of a television program displayed on the EPG screen by selecting the program by the operation section; and
temporary program preparing means for preparing a temporary program that enables the user to select a television program not displayed on the EPG screen since its electronic program information is absent,
wherein the EPG screen displaying function means displays the temporary program at a location on the EPG screen where a television program based on the electronic program information is not displayed, and
the program reserving means enables the user to make at least one of a viewing reservation and a recording reservation of a television program of a channel and broadcast time, which correspond to the location where the temporary program is displayed, by selecting the temporary programs displayed on the EPG screen by the operation section.

3. A digital/analog broadcast receiver according to claim 2, wherein a plurality of time intervals are preset as time intervals in the temporary program preparing means, and
the time interval is selected by the operation section, and responsively a temporary program is prepared having the selected time interval.
